(19) United States
(12) Patent Application Publication
(10) Pub. No.: US 2026/0062091 A1
(43) Pub. Date: Mar. 5, 2026

(54) AIR SPRINGS FOR BICYCLE FRONT FORKS AND OTHER BICYCLE COMPONENTS

(71) Applicant: SRAM, LLC, CHICAGO, IL (US)

(72) Inventors: ALEXANDER ROSENBERRY, COLORADO SPRINGS, CO (US); TIMOTHY LYNCH, COLORADO SPRINGS, CO (US)

(73) Assignee: SRAM, LLC, CHICAGO, IL (US)

(21) Appl. No.: 18/816,508

(22) Filed: Aug. 27, 2024

(51) Int. Cl. B62K 25/08; F16F 9/02; F16F 9/32

(52) U.S. Cl. CPC B62K 25/08; F16F 9/0218; F16F 9/3242; B62K 2201/08

(57) ABSTRACT

Example air springs for bicycle front forks and other bicycles components are described herein. An example air spring includes a tube having a first end and a second end, a cap coupled to the tube at or near the first end, a sealhead in the tube near the second end such, a spacer in the tube, the spacer disposed between the sealhead and the second end, a first retaining element coupled to an inner surface of the tube and engaged by an end of the spacer to prevent the spacer from moving axially out of the second end of the tube, and a second retaining element coupled to the inner surface of the tube. The second retaining element is spaced further from the second end than the first retaining element. The second retaining element has an inner diameter that is less than an outer-most diameter of the sealhead.

### FIELD OF THE DISCLOSURE

This disclosure relates generally to bicycle components and, more specifically, to air springs for bicycle front forks and other bicycle components.

### BACKGROUND

Bicycles are known to have suspension components. Suspension components are used for various applications, such as cushioning impacts, vibrations, or other disturbances imparted to the bicycle during use. A common application for suspension components on bicycles is for cushioning impacts or vibrations experienced by the rider when the bicycle is ridden over bumps, ruts, rocks, potholes, and/or other obstacles. These suspension components include rear and/or front wheel suspension components. For example, some bicycles include a front fork with telescoping legs that incorporate a spring and/or damper system. The front fork compresses and expands when riding over obstacles to help cushion impacts and/or vibrations felt by the rider. Bicycles are also known to have height adjustable seat posts. A height adjustable seat post can be used to adjust a riding height of the seat while riding the bicycle. Suspension components and height adjustable seats posts often include an air spring, which is used to reduce impacts and vibrations as well return the component to its original or extended state.

### SUMMARY

An example air spring for a bicycle component disclosed herein includes a tube having a first end and a second end opposite the first end, a cap coupled to the tube at or near the first end, a sealhead in the tube near the second end such that a sealed pressure chamber is formed in the tube between the cap and the sealhead, and a spacer in the tube. The spacer is disposed between the sealhead and the second end. The air spring also includes a first retaining element coupled to an inner surface of the tube and engaged by an end of the spacer to prevent the spacer from moving axially out of the second end of the tube. The air spring further includes a second retaining element coupled to the inner surface of the tube. The second retaining element is spaced further from the second end than the first retaining element. The second retaining element has an inner diameter that is less than an outer-most diameter of the sealhead such that the second retaining element blocks the sealhead from exiting the second end of the tube.

Another example air spring for a bicycle component disclosed herein includes a tube having a first end and a second end opposite the first end, a piston in the tube, a rod coupled to the piston, and a sealhead in the tube near the second end. The rod extends through a channel in the sealhead. The air spring also includes a spacer in the tube to space the sealhead from the second end. The spacer has a first end and a second end opposite the first end. The second end of the spacer is closest to the second end of the tube. The air spring further includes a retaining element coupled to an inner surface of the tube. The retaining element is located further from the second end of the tube than the second end of the spacer. The retaining element has an inner diameter that is less than an outer-most diameter of the sealhead, such that when the spacer is removed from the tube, the sealhead is moveable toward the second end of the tube but blocked by the retaining element from exiting the second end of the tube.

Another example air spring for a bicycle component disclosed herein includes a tube having a first end and a second end opposite the first end. The tube has internal threads adjacent the first end. The tube defines a sealed pressure chamber. The air spring also includes a cap coupled threadably coupled to the tube. The cap has external threads that are threadably engaged with the internal threads on the tube and defining an axial interface locking length. An outer side surface of the cap has a vent groove that extends in an axial direction through the external threads. The air spring further includes a seal coupled to the cap and in sealing contact with an inner surface of the tube. The seal is spaced from the first end of the tube by a seal gap that is less than the axial interface locking length such that as the cap is being unscrewed from the tube, the seal loses sealing contact with the inner surface before the cap is fully decoupled from the tube and the vent groove enables fluid to vent from the sealed pressure chamber.

### BRIEF DESCRIPTION OF THE DRAWINGS

FIG. 1 is a side view of an example bicycle that may employ any of the example air spring and/or bicycle components disclosed herein.

FIG. 2 is front view of an example front fork that can be implemented on the example bicycle of FIG. 1.

FIG. 3 is a side view of the example front fork of FIG. 2.

FIG. 4 is a cross-sectional view of the example front fork of FIG. 2 taken along line A-A of FIG. 2 and showing an example air spring incorporated into one of the legs of the example front fork.

FIG. 5 is a side view of the example air spring of FIG. 4.

FIG. 6 is a cross-sectional view of the example air spring of FIG. 5 taken along line B-B of FIG. 5.

FIG. 7 is an enlarged cross-sectional view of the callout in FIG. 6 showing the lower portion of the example air spring in an assembled state.

FIG. 8 shows the lower portion of the example air spring of FIG. 7 in a partially disassembled state.

FIG. 9 is an enlarged cross-sectional view of an upper portion of the example air spring of FIG. 4 showing an example cap in a fully coupled state.

FIG. 10 shows the upper portion of the example air spring of FIG. 9 with the cap in a partially removed state.

FIG. 11 is a perspective view of the example cap of FIG. 9.

FIG. 12 is a side view of the example cap of FIG. 11.

FIG. 13 is a cross-sectional view of the example cap taken along line C-C of FIG. 12.

FIG. 14 is a cross-sectional view of the example cap taken along line D-D of FIG. 13.

The figures are not to scale. Instead, the thickness of the layers or regions may be enlarged in the drawings. In general, the same reference numbers will be used throughout the drawing(s) and accompanying written description to refer to the same or like parts.

Descriptors "first," "second," "third," etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor "first" may be used to refer to an element in the detailed description, while the same element may be referred to in a claim with a different descriptor such as "second" or "third." In such instances, it should be understood that such descriptors are used merely for ease of referencing multiple elements or components.

### DETAILED DESCRIPTION

Bicycles are known to have front forks that function as a suspension component. For example, a front fork typically includes a crown, a steerer tube extending upward from the crown, and two legs extending downward from the crown. Each leg has an upper cylindrical tube that is coupled to the crown and a lower cylindrical tube that is to be connected to the front wheel. The upper and lower cylindrical tubes are arranged in a telescopic relationship that enables the front fork to compress and expand to absorb shocks and vibrations. Some front forks include spring and damper systems. For example, some front forks include an air spring incorporated into one of the legs and a damper incorporated into the other leg. The air spring enables the front fork to compress or contract when riding over a bump or obstacle, thereby reducing the transmission of shocks and vibrations to the rider, and then returns the fork to an expanded state after the compressive force is removed. The damper controls the speed at which the fork compresses and expands.

An air spring includes a sealed pressure chamber. In some examples, the sealed pressure chamber is defined inside an upper tube of one of the legs. The sealed pressure chamber is sealed at one end by a cap and at the opposite end by a sealhead. In some examples, a valve (e.g., a Schrader valve) is incorporated into the cap and can be used to add pressurized air (or another fluid) into the sealed pressure chamber and/or evacuate air from the sealed pressure chamber. The air spring includes a piston that is disposed in the sealed pressure chamber and divides the sealed pressure chamber into first and second chambers (sometimes referred to as positive and negative chambers). The air spring also includes a rod that is coupled to the piston and extends outward through the sealhead. A distal end of the rod is coupled to the bottom of the lower tube of the leg. When the front fork is compressed, such as when riding over a bump, the upper and lower tubes are pushed toward each other. As such, the rod pushes the piston toward one of the ends of the tube, which increases the pressure in the positive chamber and decreases the pressure in the negative chamber. After the compressive force is removed, the increased pressure in the positive air chamber and the decreased pressure in the negative air chamber acts to move the piston downward, which cause the front fork to expand back to the original riding setup.

A front fork, including its air spring, often needs to be disassembled and/or taken apart for maintenance or repair. Typically, before a person begins to disassemble the air spring, it is recommended that the person depressurize the sealed chamber to ease the disassembly process. The person can open the valve in the cap to depressurize the sealed chamber. Then, once the sealed pressure chamber is depressurized, the person can continue to remove the cap and/or the sealhead and remove the piston and rod from the tube. However, some people may forget or choose not to follow proper procedures to use the valve to depressurize the sealed chamber prior to disassembling the air spring. When the person begins to loosen certain parts, the highly pressurized sealed chamber can result in parts being ejected from the air spring at a high velocity, which can cause damage to the parts of the air spring and/or potential impact to persons in the vicinity.

Disclosed herein are example air springs for front forks and other bicycle components that include features to prevent parts of the air spring from being ejected from the tube during disassembly when the tube is still pressurized. Also disclosed herein are example air springs that include features to automatically vent and/or depressurize the sealed pressure chamber when the cap and/or the sealhead is/are being decoupled from the tube. This depressurization eliminates the risk of parts being ejected from the tube under high pressure. This automatic depressurization also reduces disassembly time and makes disassembly easier.

The example air springs disclosed herein can be used in front forks. The example air springs disclosed herein call also be used in other suspension components, such a shock absorber (e.g., a rear shock absorber), or a height adjustable seat post, as well as any other bicycle component. Thus, the example air springs disclosed herein are not limited to only front forks.

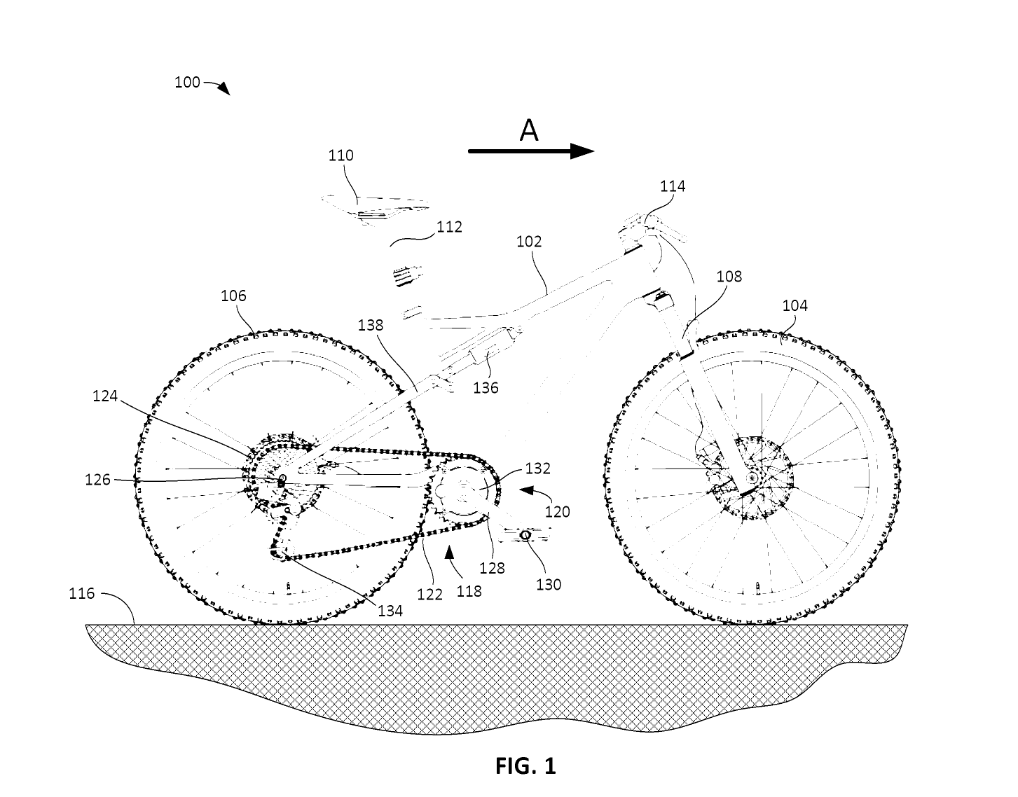

Turning now to the figures, FIG. 1 illustrates one example of a human powered vehicle on which the example air springs disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 coupled to the frame 102 (e.g., near the rear end of the frame 102 relative to the forward direction A) via a seat post 112. The bicycle 100 also includes handlebars 114 coupled to the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device to move the chain 122 through gears on the chainring 132.

The example bicycle 100 includes a suspension system having one or more suspension components. In this example, the front fork 108 is implemented as a front suspension component. The front fork 108 is or integrates a shock absorber that includes a spring and a damper. Further, in the illustrated example, the bicycle 100 includes a rear suspension component 136, which is a shock absorber, referred to herein as the rear shock absorber 136. The rear shock absorber 136 is coupled between two portions of the frame 102, including a swing arm 138 coupled to the rear wheel 106. The front fork 108 and the rear shock absorber 136 absorb shocks and vibrations while riding the bicycle 100 (e.g., when riding over rough terrain). In other examples, the front fork 108 and/or the rear shock absorber 136 may be integrated into the bicycle 100 in other configurations or arrangements. Further, in other examples, the suspension system may employ only one suspension component (e.g., only the front fork 108) or more than two suspension components (e.g., an additional suspension component on the seat post 112) in addition to or as an alternative to the front fork 108 and rear shock absorber 136.

While the example bicycle 100 depicted in FIG. 1 is a type of mountain bicycle, the example air springs and front forks disclosed herein can be implemented on other types of bicycles. For example, the disclosed air springs and front forks may be used on road bicycles, as well as bicycles with mechanical (e.g., cable, hydraulic, pneumatic, etc.) and non-mechanical (e.g., wired, wireless) drive systems. The disclosed air springs and front forks may also be implemented on other types of two-wheeled, three-wheeled, and four-wheeled human powered vehicles. Further, the example air springs and front forks can be used on other types of vehicles, such as motorized vehicles (e.g., a motorcycle, a car, a truck, etc.).

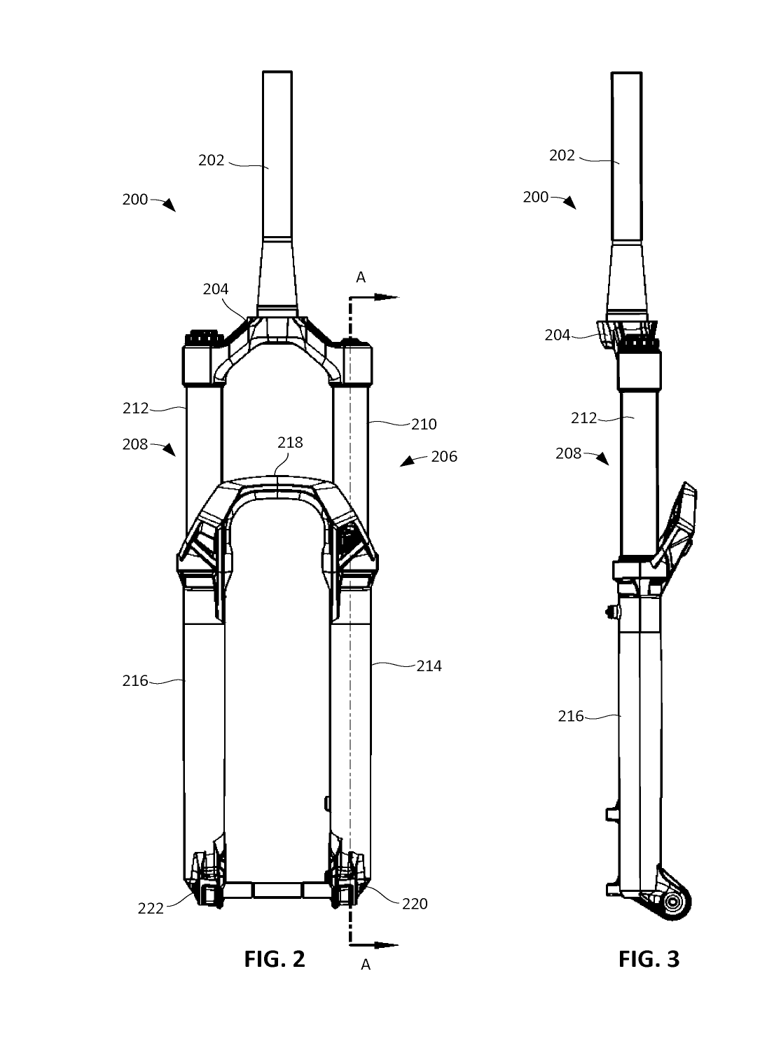

FIG. 2 is a front view of an example front fork 200 (a suspension component) that can be implemented as the front fork 108 and used on the bicycle 100 of FIG. 1. FIG. 3 is a side view of the front fork 200. The example front fork 200 includes an example air spring, disclosed in further detail herein. In the illustrated example of FIGS. 2 and 3, the front fork 200 includes a steerer tube 202, a crown 204, a first leg 206, and a second leg 208. The steerer tube 202 is coupled to the crown 204 and extends outward (e.g., upward) from a top of the crown 204. The steerer tube 202 is to be inserted through a head tube on the frame 102 (FIG. 1) of the bicycle 100 and coupled (e.g., via a stem) to the handlebars 114 (FIG. 1). The first and second legs 206, 208 are coupled to the crown 204 and extend outward (e.g., downward) from a bottom of the crown 204, opposite the steerer tube 202. The first and second legs 206, 208 are to be coupled to the front wheel 104 (FIG. 1).

In the illustrated example, the first and second legs 206, 208 include first and second upper tubes 210, 212, respectively, and first and second lower tubes 214, 216, respectively. The upper and lower tubes 210, 212, 214, 216 are sometimes referred to as stanchions or leg portions. The first and second upper tubes 210, 212 are coupled to and extend downward from the crown 204. The front fork 200 includes an arch 218 (sometimes referred to as a fork brace or stabilizer) coupled between the lower tubes 214, 216. In some instances, the upper tubes 210, 212 are referred to as an upper tube assembly, while the lower tubes 214, 216 and the arch 218 are referred to as a lower tube assembly. The first and second lower tubes 214, 216 include respective front wheel attachment portions 220, 222, such as holes (e.g., eyelets) or dropouts, for attaching the front wheel 104 (FIG. 1) to the front fork 200. In this example, the upper and lower tubes 210, 212, 214, 216 are cylindrical, but in other examples can have a different cross-sectional shape.

The first and second upper tubes 210, 212 are slidably received within the respective first and second lower tubes 214, 216. Thus, the first and second upper tubes 210, 212 form a telescopic arrangement with the respective first and second lower tubes 214, 216. Although the depicted embodiment shows the upper tubes 210, 212 received in the lower tubes 214, 216, it should also be appreciated that the lower tubes 214, 216 may be received in the upper tubes 210, 212, for example in what may be known as an upside-down arrangement. During a compression stroke, the first and second upper tubes 210, 212 move into or toward the respective first and second lower tubes 214, 216, and during a rebound stroke, the first and second upper tubes 210, 212 move out of or away from the respective first and second lower tubes 214, 216. The first and second upper tubes 210, 212 and the first and second lower tubes 214, 216 are moveable between a fully extended position (also referred to as a top-out position) and a fully compressed position (also referred to as a bottom-out position).

The front fork 200 includes both a spring and a damper. In this example, the spring is disposed in and/or otherwise integrated into the first leg 206, and the damper is disposed in and/or otherwise integrated into the second leg 208. It should also be appreciated that the damper and the spring may be in opposite legs to those shown or that the damper and spring may be disposed in the same leg, for example in a single-leg fork. The spring is configured to resist compression of the top ends of the legs 206, 208 toward the bottom ends and return the tubes 210, 212, 214, 216 to the extended position after compression occurs. The damper is configured to limit the speed at which the compression/extension occurs and/or otherwise absorb vibrations.

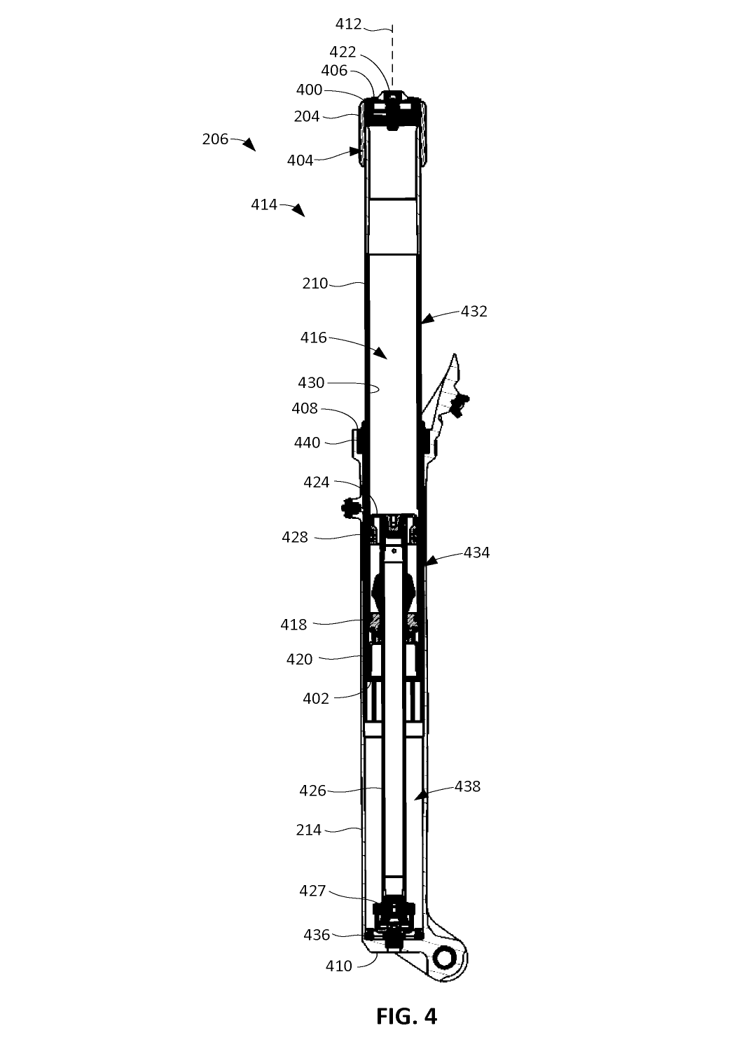

FIG. 4 is a cross-sectional view of the first leg 206 taken along line A-A of FIG. 2. As shown in FIG. 4, the first upper tube 210 has a first end 400 (which may also be referred to as a top end) and a second end 402 (which may also be referred to as a bottom end) opposite the first end 400. The first upper tube 210 is coupled to the crown 204 at or near the first end 400. In the illustrated example, a portion of the first upper tube 210 extends into an opening 404 in the crown 204. In some examples, the first upper tube 210 is secured to the crown 204 by a cap 406 that is coupled (e.g., threadably coupled) to the first upper tube 210 at or near the first end 400. Additionally or alternatively, the first upper tube 210 can be coupled to the crown 204 via another mechanical and/or chemical fastening technique (e.g., threaded fasteners, welding, an adhesive, etc.). The first lower tube 214 has a first end 408 and a second end 410 opposite the first end 408. The first upper tube 210 is inserted into the first lower tube 214. In particular, the second end 402 of the first upper tube 210 is disposed within the first lower tube 214. This type of configuration is sometimes referred to as a right side up fork. The first end 400 of the first upper tube 210 and the second end 410 of the first lower tube 214 form first and second distal ends of the suspension component. During compression, the first end 400 and the second end 410 are moved toward each other, and during extension or rebound, the first end 400 and the second end 410 are moved away from each other. Thus, the first upper and lower tubes 210, 214 form a telescopic arrangement. The first upper and lower tubes 210, 214 are moveable along a central axis 412 of the first leg 206. The first upper and lower tubes 210, 214 define an interior chamber or region.

The first leg 206 includes and/or otherwise integrates an example air spring 414. The air spring 414 includes the first upper tube 210 and a sealed pressure chamber 416 (which may also be referred to as a pneumatic chamber) defined by an interior of the first upper tube 210. However, in other examples, the sealed pressure chamber 416 can be defined by a separate tube or body within the first upper tube 210. The air spring 414 includes a sealhead 418 (e.g., a piston, a plug, a disc, etc.) coupled to and disposed in the first upper tube 210 near the second end 402 that seals the bottom of the sealed pressure chamber 416. In this example, the sealhead 418 is spaced from the second end 402 of the first upper tube 210 by a spacer 420, disclosed in further detail herein. The cap 406 seals the top of the sealed pressure chamber 416. As such, the sealed pressure chamber 416 is formed in the first upper tube 210 between the cap 406 and the sealhead 418. The sealed pressure chamber 416 is filled with pressurized fluid, such as pressurized air. In some examples, the air spring 414 includes a valve 422 (e.g., a Schrader valve) that can be to add or remove the pressurized air to/from the sealed pressure chamber 416. In this example, the valve 422 is coupled to or integrated into the cap 406, but in other examples can be disposed in other locations (e.g., on a side of the first upper tube 210).

In the illustrated example, the air spring 414 also includes a piston 424 and a rod 426 coupled to the piston 424. The piston 424 is disposed in the sealed pressure chamber 416 in the first upper tube 210. The piston 424 is slidable linearly (e.g., up and down) within the first upper tube 210. One end of the rod 426 is coupled (e.g., threadably coupled) to the piston 424. The rod 426 extends downward through the sealhead 418 and is coupled and its opposite end to the second end 410 of the first lower tube 214. In the illustrated example, the rod 426 is coupled to the second end 410 by a mount or jounce 427.

In the illustrated example of FIG. 4, the air spring 414 includes a piston seal 428 that is coupled to the piston 424 and is in sealing contact with an inner surface 430 of the first upper tube 210. As such, the piston 424 divides the sealed pressure chamber 416 into a first chamber 432, referred to herein as a positive air chamber 432, and a second chamber 434, referred to herein as a negative air chamber 434. The positive air chamber 432 is between the piston seal 428 and the cap 406, and the negative air chamber 432 is between the piston seal 428 and the sealhead 418. In some examples, the positive air chamber 432 is filled with a mass of air having a higher pressure than ambient pressure. Therefore, in this example, the positive air chamber 432 forms a pressurized chamber, sometimes referred to as a highly pressurized zone or positive spring chamber, above the piston 424. The negative air chamber 434 is also filled with air and forms a negative spring chamber below the piston 424. When the front fork 200 compresses and the ends of the first upper and lower tubes 210, 214 move toward each other, such as when riding over a bump, the rod 426 moves the piston 424 toward the first end 400 of the first upper tube 210. As a result, the volume of the positive air chamber 432 decreases and, thus, the pressure of the air within the positive air chamber 432 increases. Conversely, the volume of the negative air chamber 434 increases and therefore the pressure of the air in the negative air chamber 434 decreases. After the compressive force is removed, the increased pressure in the positive air chamber 432 and the decreased pressure in the negative air chamber 434 acts to move the piston 424 away from the first end 400, which pushes the ends of the first upper and lower tubes 210, 214 away from each other, thereby acting as a spring to return the front fork 200 to its original or riding set up. The second upper and lower tubes 212, 216 (FIG. 2) similarly follow this motion. In some examples, the piston 424 may incorporate a valve, such as a poppet or shim stack, that can be controlled to affect the compression and/or rebound rates of the spring.

As shown in FIG. 4, the front fork 200 includes a bottom-out pad 436 in the bottom of the interior region of the first lower tube 214. When the first upper and lower tubes 210, 214 are fully compressed, the second end 402 of the first upper tube 210 engages the bottom-out pad 436, which may buffer a hard stop and defines the bottom-out position.

In some examples, an interior region 438 of the first lower tube 214 has a sealed volume of air. For example, a wiper seal 440 is coupled to the first lower tube 214 near the first end 408. The wiper seal 440 slides along an outer surface of the first upper tube 210 as the front fork 200 compresses or rebounds. The wiper seal 440 forms a fluid tight seal between the first upper and lower tubes 210, 214. Further, the second end 410 of the first lower tube 214 is sealed by the mount 427. As such, the air in the interior region 438 is sealed from the outside environment. This helps to shield the internals from outside contaminants (e.g., dirt, debris, etc.). This also helps to maintain oil or other lubricant in the interior region 438. During a compression event, when the first upper tube 210 is moved into the first lower tube 214, the volume of the interior region 438 decreases, which increases the pressure of the air sealed in the interior region. This increased pressure acts as an additional spring force that biases or pushes the upper and lower tubes 210, 214 back to their original or extended position.

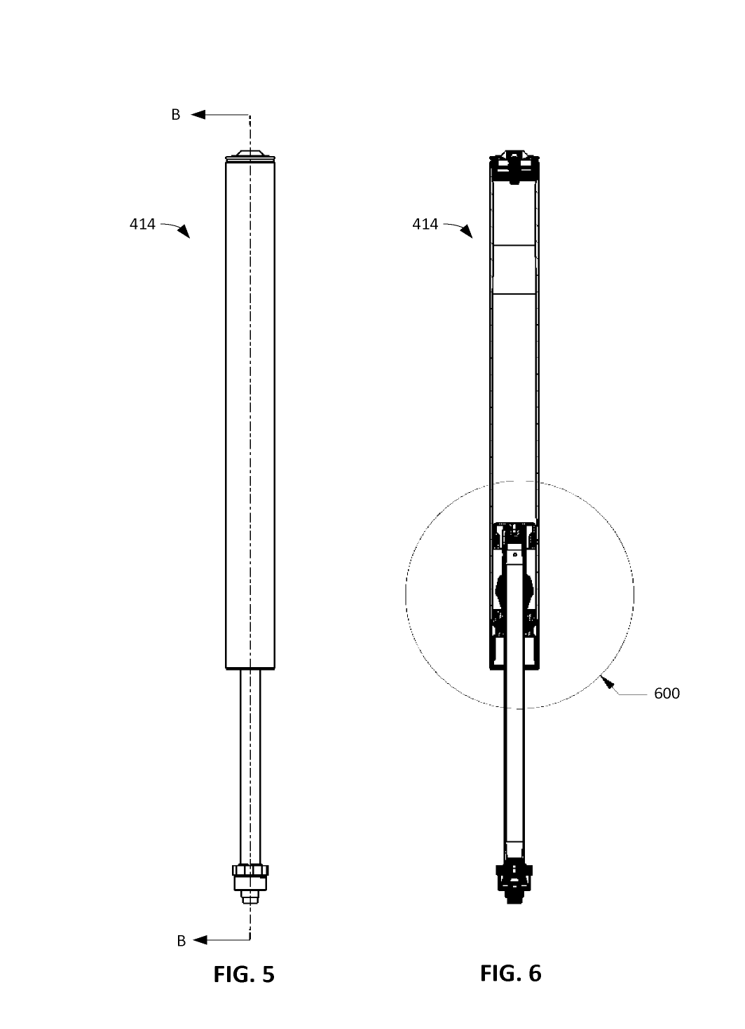

FIG. 5 is a side view of the air spring 414 as removed from the lower tube 214. FIG. 6 is a cross-sectional view of the air spring 414 taken along line B-B of FIG. 5.

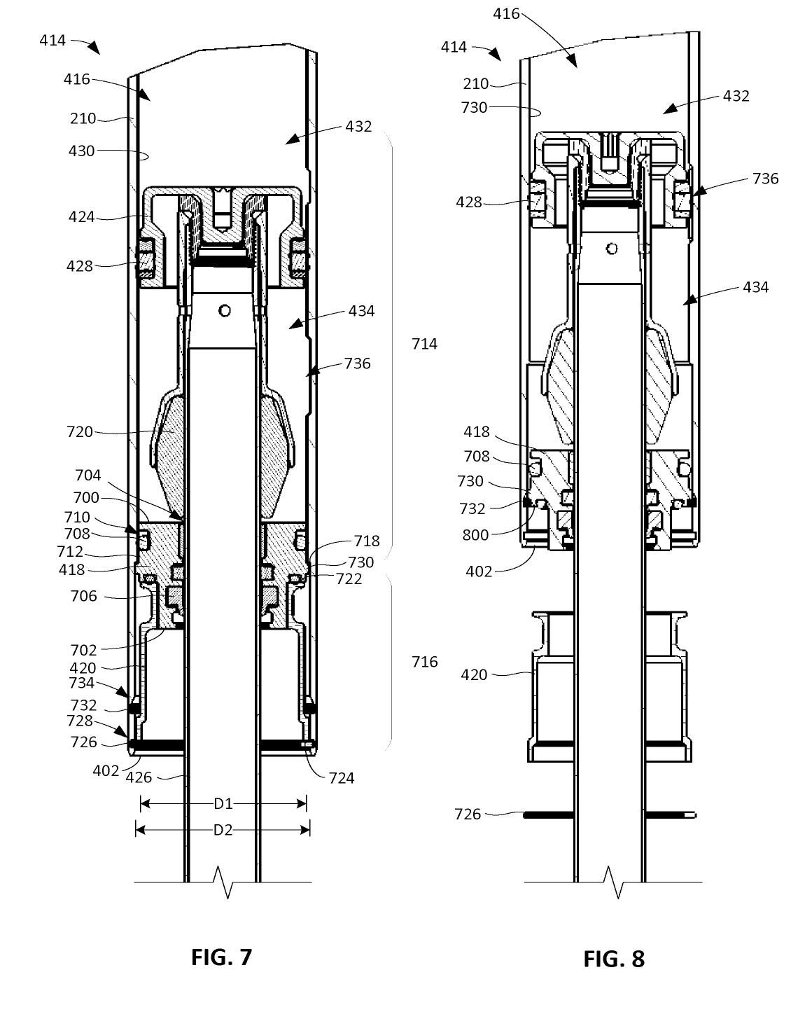

FIG. 7 is an enlarged view of the callout 600 of FIG. 6 showing the lower end of the first upper tube 210. As disclosed above, the piston 424 is disposed in the sealed pressure chamber 416 in the first upper tube 210 and divides the sealed pressure chamber 416 into the positive air chamber 432 and the negative air chamber 434. The piston seal 428 is coupled to the piston 424 (e.g., disposed in a seal gland on the piston 424) and in sealing contact with the inner surface 430 of the first upper tube 210.

In the illustrated example of FIG. 7, the sealhead 418 is disposed in the first upper tube 210 near the second end 402. The sealhead 418 has a first side 700, a second side 702 opposite the first side 700, and a channel 704 extending through the sealhead 418 between the first side 700 and the second side 702. The rod 426 extends through the channel 704. In the illustrated example, the air spring 414 includes a shaft seal 706 disposed in the channel 704 and coupled to the sealhead 418. The shaft seal 706 enables the sealhead 418 to slide smoothly up and down along the rod 426 while also forming a pressure tight seal between the sealhead 418 and the rod 426 to prevent fluid leakage through the sealhead 418. The air spring 414 also includes a seal 708 (e.g., an o-ring) coupled to the sealhead 418. The seal 708 is in sealing contact with the inner surface 430 of the first upper tube 210 and thereby forms a fluid tight seal between the sealhead 418 and the inner surface 430. In the illustrated example, the seal 708 is disposed in a seal gland 710 formed in an outer side surface 712 of the sealhead 418. As such, the seal 708 is coupled to and moves with the sealhead 418 (e.g., during assembly or disassembly). In other examples, the seal 708 can be coupled to the sealhead 418 via other chemical or mechanical techniques (e.g., threaded fasteners, adhesives, etc.).

As shown in FIG. 7, the first upper tube 204 has a first section 714 with a first inner diameter D1 and a second section 716 with a second inner diameter D2 adjacent the second end 402. The second inner diameter D2 is larger than the first inner diameter D1. The first upper tube 204 has a shoulder 718 formed between the first section 714 and the second section 716. In the illustrated example, the seal 708 is in sealing contact with the inner surface 430 of the first upper tube 210 along the first section 714.

In some examples, the air spring 414 includes a top-out bumper 720 that is coupled to the rod 426 below the piston 424. The top-out bumper 720 engages the first side 700 of the sealhead 418 when the air spring 414 is in the fully extended or top-out position. The top-out bumper 720 can be constructed of a compliant or elastic material, such as rubber, to reduce the impact when reaching the top-out position.

In the illustrated example, the air spring 414 includes the spacer 420. The spacer 420 is disposed in the first upper tube 210 between the sealhead 418 and the second end 402. The spacer 420 is used to position or space the sealhead 418 a certain distance from the second end 402 to maintain a certain volume of space in the second end 402. In particular, when the first upper and lower tubes 210, 214 (FIG. 4) are fully compressed, the second end 402 of the first upper tube 210 engages the bottom-out pad 436 (FIG. 4), which reduces the volume of space in the interior region 438 in the first lower tube 214. The spacer 420 creates an additional space or volume in the second end 402 of the first upper tube 210 for the air in the interior region 438 to consume. Otherwise, if there were no space and the volume in the interior region 438 was reduced to zero or close to zero, the pressure in the interior region 438 would increase significantly near a bottom-out event, and would create an overly-progressive spring rate, which is undesirable by riders.

In the illustrated example, the spacer 420 is cylindrical (e.g., a tube or sleeve shape) and has a first end 722 and a second end 724 opposite the first end 722. The first end 722 is engaged (directly or in directly) with the sealhead 418. The second end 724 is closest to the second end 402 of the first upper tube 210. In the illustrated example, the air spring 414 includes a first or primary retaining device to secure the spacer 420 in the first upper tube 210. In this example, the first retaining device may comprise a retaining element such as a first retaining ring 726. The first retaining ring 726 is coupled to the inner surface 430 of the first upper tube 210. In particular, in this example, the first retaining ring 726 is disposed in a first annular groove 728 formed on the inner surface 430 of the first upper tube 210. The first retaining ring 726 may be sized and shaped to interact with other components such as the spacer 420. In the present example, the inner diameter of the first retaining ring 726 is smaller than an outer-most diameter of the spacer 420. As such, the second end 724 of the spacer 420 is engaged with the first retaining ring 726, which thereby blocks or prevents the spacer 420 from moving axially out of the second end 402 of the first upper tube 210. The first retaining ring 726 can be implemented as any type of internal retaining ring such as a circlip or e-clip, for example, but in other examples can be implemented as other types of retaining elements. Further, in other examples, the primary retaining device can be implemented by other devices such as threads, pins, interlock features, or a circumferential clamping mechanism.

In the illustrated example, the sealhead 418 has a flange 730 that is engaged with the shoulder 718 formed on the inner surface 430 of the first upper tube 210. The shoulder 718 helps to position in the sealhead 418 in the correct location and prevents the sealhead 418 from being pushed further up into the sealed pressure chamber 416. The spacer 420 is dimensioned to maintain the sealhead 418 engaged with the shoulder 718. As such, the sealhead 418 is axially constrained between the shoulder 718 and the spacer 420.

In order to remove the spacer 420 from the first upper tube 210, a person must first remove the first retaining ring 726 from the first annular groove 728. For example, a person may use a tool, such as retaining ring pliers, to grasp the first retaining ring 726 and remove it from the first annular groove 728. After the first retaining ring 726 is removed, the spacer 420 can be slid out of and removed from the second end 402 of the first upper tube 210.

As disclosed above, before disassembly of the air spring 414, a person should first depressurize the sealed pressure chamber 416 by opening the valve 422 (FIG. 4) and venting the pressured air in the sealed pressure chamber 416. However, a person may forget or otherwise neglect to depressurize the sealed pressure chamber 416. If the sealed pressure chamber 416 still contains pressurized air when the first retaining ring 726 and the spacer 420 are removed, the pressurized air causes the sealhead 418 to be pushed downward toward the second end 402. To prevent the sealhead 418 from being ejected from the second end 402 of the first upper tube 210, the example air spring 414 includes a secondary or second retaining device, which, in this example, is implemented with a retaining element configured as a second retaining ring 732. The second retaining ring 732 is coupled to the inner surface 430. In particular, in this example, the second retaining ring 732 is disposed in a second annular groove 734 formed on the inner surface 430 of the first upper tube 210. The second retaining ring 732 is spaced further from the second end 402 than the first retaining ring 726 is spaced from the second end 402. Also, the second retaining ring 732 is located further from the second end 402 than the second end 724 of the spacer 420. However, any suitable configuration to facilitate removal of the first retaining ring 726 then the second retaining ring 732 may alternatively be provided. The second retaining ring 732 has an inner diameter that is less than an outer-most diameter of the sealhead 418. As such, when the first retaining ring 726 and the spacer 20 are removed from the first upper tube 210, the sealhead 418 may move downward toward the second end 402 of the first upper tube 210 (due to internal pressure), but the sealhead 418 is blocked by the second retaining ring 732 from exiting the second end 402 of the first upper tube 210, as described in further detail in connection with FIG. 8. The second retaining ring 732 does not interfere with the spacer 420 from being installed or removed. In some examples, the second retaining ring 732 is not in contact with the spacer 420. However, in other examples, the outer surface of the spacer 420 may be in sliding contact with the inner surface of the second retaining ring 732. Similar to the first retaining ring 726, the second retaining ring 732 can be implemented as a circlip (e.g., a round wire circlip) or e-clip. In other examples, the second retaining device can be implemented by other devices such as threads or a pinned joint.

FIG. 8 shows an example in which the first retaining ring 726 and the spacer 420 have been removed from the second end 402 of the first upper tube 210. If the sealed pressure chamber 416 is still pressurized, the sealhead 418 is pushed downward toward the second end 402. However, as disclosed above, the inner diameter of the second retaining ring 732 is smaller than an outer-most diameter of the sealhead 418. In this example, the flange 730 of the sealhead 418 defines the outer-most diameter of the sealhead 418. As such, the flange 730 of the sealhead 418 engages the second retaining ring 732, which blocks and/or otherwise prevents the sealhead 418 from being ejected second the second end 402.

As shown in FIG. 8, the sealhead 418 has an extension portion 800 extending from the flange 730 toward the second end 402. The extension portion 800 has an outer dimaeter that is less than the inner diameter of the second retaining ring 732. As such, when the sealhead 418 is moved toward the second end 402, as shown in FIG. 8, the flange 730 engages the second retaining ring 732 and the extension portion 800 extends at least partially through the second retaining ring 732. In some examples, the extension portion 800 is sized such that the extension portion 800 is engaged or relatively close to the inner diameter surface of the second retaining ring 732. This blocks or otherwise prevents a person from being able to remove the second retaining ring 732. In particular, the second retaining ring 732 can be implemented by an internal circlip. Circlips have internal tab holes that can be grasped with pliers and pinched radially inward to reduce the outer diameter of the circlip and remove the circlip from the annular groove. However, the extension portion 800 of the sealhead 418 extending through the second retaining ring 732 may block or prevent the pliers from being able to access the tab holes on the second retaining ring 732. Further, even if the tab holes could be accessed, the extension portion 800 of the sealhead 418 blocks and/or otherwise prevents the second retaining ring 732 from being pinched radially inward and released from the second annular groove 734. Therefore, the only way to remove the second retaining ring 732 is to push the sealhead 418 upward and away from the second retaining ring 732. However, if the sealed pressure chamber 416 is still pressurized, moving the sealhead 418 upwards is extremely difficult if not impractical. This serves as a reminder to and/or forces the person to depressurize the sealed pressure chamber 416. After the person properly depressurizes the sealed pressure chamber 416 (e.g., by opening the valve 422 (FIG. 2)), the person can then push upward on the sealhead 418 to move the sealhead 418 away from the second retaining ring 732. Then, the person can access the second retaining ring 732 with the pliers to remove the second retaining ring 732. Once the second retaining ring 726 is removed, the sealhead 418 and the other components inside the first upper tube 210 can be removed.

In some examples, the seal 708 maintains sealing contact with the inner surface 430 when the sealhead 418 is moved downward to the position shown in FIG. 8. As such, a person must depressurize the sealed pressure chamber 416 to enable them to be able to push the sealhead 418 upward and away from the second retaining ring 732. However, in other examples, the inner diameter of the first upper tube 210 may be dimensioned such that when the sealhead 418 moves downward, the seal 708 loses sealing contact with the inner surface 430. For example, as shown in FIG. 7, the first and second retaining rings 726, 732 are coupled to the inner surface 430 along the second section 716 having the larger diameter D2. As such, when the sealhead 418 is moved downward toward the second end 402 as shown in FIG. 8, the seal 708 moves into the second section 716 and loses sealing contact with the inner surface 430 of the first upper tube 210. As such, pressurized air in the negative air chamber 434 bypasses the seal 708 and vents to the atmosphere, thereby automatically depressurizing at least the negative air chamber 434 of the sealed pressure chamber 416. This depressurization may take a few seconds.

In some examples, as shown in FIGS. 7 and 8, the inner surface 430 of the first upper tube 210 has an equalization feature to provide fluid communication between the positive air chamber 432 and the negative air chamber 434. For example, a recess, which, in this example, is implemented as a dimple 736 extends into the inner surface 430. When the piston 424 is in a top-out position, as shown in FIG. 7, the dimple 736 is between the piston seal 428 and the second end 402. Therefore, during normal cycles of the piston 424, the piston seal 428 does not pass over the dimple 736. However, when the first retaining ring 726 and the spacer 420 are removed from the first upper tube 203 and the sealhead 418 is moved downward to the position in FIG. 8, the pressure in the positive air chamber 432 biases the piston 424 downward. As such, as shown in FIG. 8, that the piston seal 428 at least partially overlaps or passes the dimple 736 and loses full sealing contact with the inner surface 430, which enables airflow between the positive and negative air chambers 432, 434. Therefore, the highly pressurized air in the positive air chamber 432 can vent or flow into the negative air chamber 434, and, as explained above, can bypass the seal 708 and vent to the atmosphere. Therefore, the entire sealed pressure chamber 416 may be automatically depressurized when the spacer 420 is removed and the sealhead 418 moves downward to the position shown in FIG. 8. This depressurization may take only a few seconds. Then, after the sealed pressure chamber 416 is depressurized, the person can push upward on the sealhead 418 to move the sealhead 418 away from the second retaining ring 732 to access the second retaining ring 732 with the tool.

In the illustrated example of FIG. 7, the second retaining ring 732 is spaced from the flange 730 of the sealhead 418. As such, when the first retaining ring 726 and the spacer 420 are removed, the sealhead 418 moves downward before it engages and is blocked by the second retaining ring 732. However, in other examples, the second retaining ring 732 can be disposed in other locations along the inner surface 430 of the first upper tube 210. For example, the second retaining ring 732 can be located below and engaged with the bottom side of the flange 730. As such, when the first retaining ring 726 and the spacer 20 are removed, the sealhead 418 may not move downward at all.

While in FIGS. 7 and 8 the upper tube 204 has one dimple 736, in other examples, the upper tube 204 can include multiple dimples, at the same axial location, that are spaced circumferentially around the inner surface 430 of the first upper tube 204. In other examples, the dimple can be implemented by another recess or circumferential discontinuity on the inner surface 430, such as an annular groove.

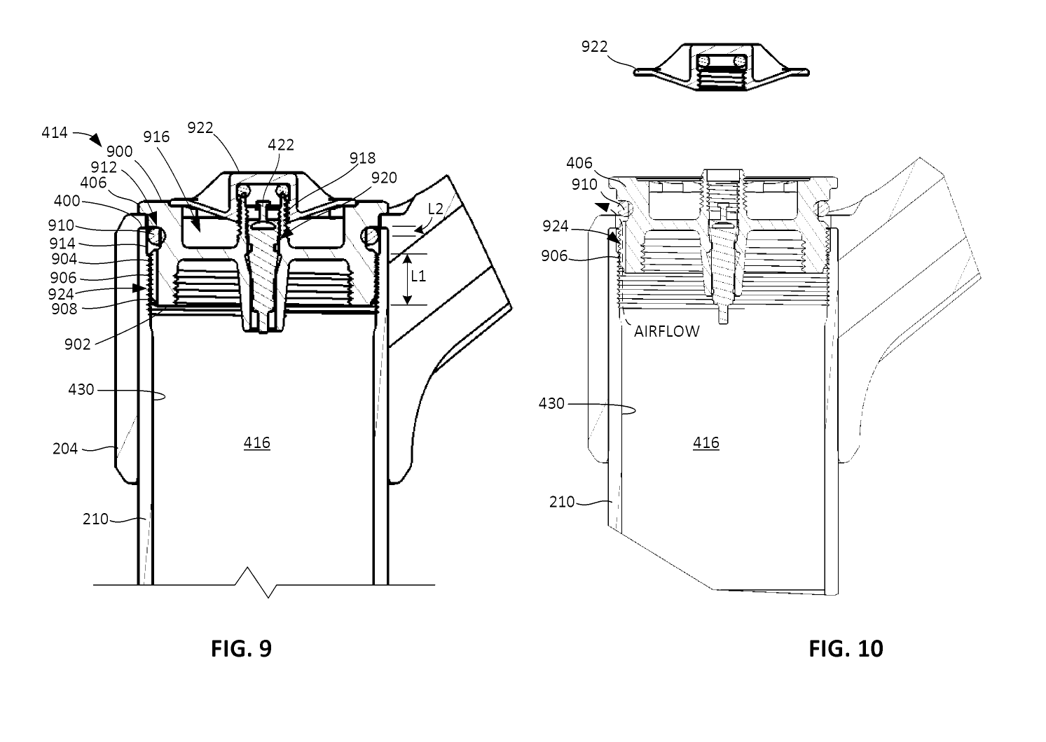

In some examples, the air spring 414 may have one or more features that enable automatic depressurization of the sealed pressure chamber 416 if the cap 406 is removed from the first end 400 while the sealed pressure chamber 416 is still pressurized. For example, FIG. 9 is a cross-sectional view of the upper portion of the first upper tube 210 and the crown 204. The cap 406 is coupled to the first upper tube 210. In this example, the cap 406 is coupled to the first upper tube 210 via a threaded connection. The cap 406 has a first side 900 (which may be referred to as a top side) and a second side 902 (which may be referred to as a bottom side) opposite the first side 900, and an outer side surface 904 between the first side 900 and the second side 902. The outer side surface 904 of the cap 406 has external threads 906. The inner surface 430 of the first upper tube 210 has internal threads 908 near the first end 400. The external threads 906 are threadably engaged with the internal threads 908. In FIG. 9, the cap 406 is fully screwed into the first upper tube 210, which seals the top of the sealed pressure chamber 416.

As shown in FIG. 9, the air spring 414 includes a seal 910 (e.g., an o-ring) coupled to the cap 406. In the illustrated example, the seal 910 is disposed in a seal gland 912 formed in the outer side surface 904 of the cap 406, but in other examples can be coupled to the cap 406 via other chemical or mechanical fastening techniques. The inner surface 430 of the first upper tube 210 has a sealing portion 914, which may be configured with a smooth wall and/or without threading, between the internal threads 908 and the first end 400. The seal 910 is in sealing contact with the sealing portion 914, which thereby forms a fluid tight seal between the cap 406 and the inner surface 430 of the first upper tube 210 to prevent fluid leakage.

In the illustrated example, the first side 900 of the cap 406 has a socket 916 that is shaped to receive a tool for gripping and rotating the cap 406. The cap 406 has a boss portion 918 that defines a channel 920 through the cap 406. The valve 422 is disposed in the channel 920. In some examples, the valve 422 is a Schrader vale that includes a stem or poppet. When the valve 422 is closed, the valve 422 blocks fluid flow through the channel 920. The valve 422 can be opened (e.g., by pressing on the poppet) to enable pressurized air to be added or vented to/from the sealed pressure chamber 416. In some examples, the air spring 414 includes a valve cover 922 to block or prevent dirt and debris from entering the channel 920 and negatively affecting the valve 422. In the illustrated example, the valve cover 922 is threadably coupled to the boss portion 918 and covers the channel 920 and the socket 916.

To disassemble the top portion of the air spring 414, the valve cover 922 can be removed (e.g., unscrewed) from the cap 406, and then the cap 406 can be removed (e.g., unscrewed) from the first upper tube 210. For example, FIG. 10 shows the valve cover 922 as removed from the cap 406. Further, as shown in FIG. 10, the cap 406 has been partially unscrewed from the first end 400 of the first upper tube 210. The seal 910 has disengaged and is no longer in sealing contact with the inner surface 430 of the first upper tube 210. As shown in FIGS. 9 and 10, the outer side surface 904 of the cap 406 has a vent groove 924. The vent groove 924 extends in an axial direction through the external threads 906. In particular, the vent groove 924 extends axially from the second side 902 of the cap 406 to the seal gland 912. The vent groove 924 enables pressurized air in the sealed pressure chamber 416 to flow between the cap 406 and the inner surface 430 of the first upper tube 210 and into the atmosphere, thereby depressurizing the sealed pressure chamber 416. As such, before the cap 406 is fully decoupled from the first upper tube 210, the sealed pressure chamber 416 is equalized or depressurized, which reduces or eliminates the risk of parts being ejected from the first upper tube 210 upon removal of the cap 406.

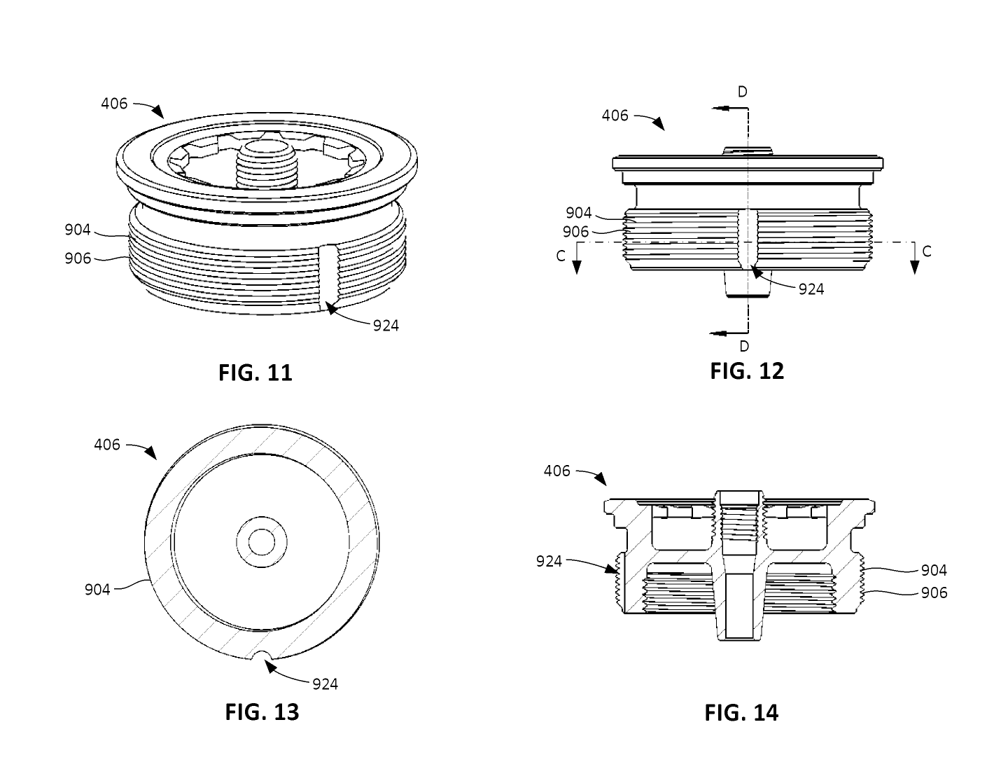

FIGS. 11-14 are different views of the cap 406. FIG. 11 is a perspective view of the cap 406, FIG. 12 is a side view of the cap 406, FIG. 13 is a cross-sectional view of the cap 406 taken along line C-C of FIG. 12, and FIG. 14 is a cross-sectional view of the cap 406 taken along line D-D of FIG. 12. The vent groove 924 can be seen in each of the views. The vent groove 924 extends in the axial direction along the outer side surface 904 and through the external threads 906. As disclosed above, the vent groove 924 forms a flow or vent path for air to escape.

Referring back to FIG. 9, the cap 406 and the first upper tube 210 are threadably coupled along an axial interface locking length L1. In this example, the axial interface locking length L1 is defined by a threaded overlap between the first upper tube 210 and the cap 406. The axial interface locking length L1 also represents the axial distance the cap 406 can be moved (e.g., screwed or unscrewed) relative to the first upper tube 210 between a fully coupled position and a fully decoupled/separated position. The fully coupled position, which is shown in FIG. 9, is defined as the position in which the threads 906, 908 are fully (e.g., maximally) engaged along the axial interface locking length L1. To decouple or remove the cap 406, the cap 406 can be unscrewed from the first end 400 of the first upper tube 210. However, even while the cap 406 is being unscrewed, as long as there are some threads overlapping, the cap 406 is still axially coupled to the first upper tube 210. The cap 406 becomes fully decoupled or separated from the first upper tube 210 when the bottom thread (in the orientation of FIG. 9) on the cap 406 passes the top thread on the first upper tube 210, at which point there is no axial coupling and the cap 406 can freely move in the axial direction away from the first end 400 of the first upper tube 210.

In the illustrated example, when the cap 406 is fully coupled to the first upper tube 210, the seal 910 is axially spaced from the first end 400 of the first upper tube 210 by a seal gap L2. The seal gap L2 is less than the axial interface locking length L1. As such, when the cap 406 is being unscrewed from the first upper tube 210, the seal 910 passes the first end 400 and loses sealing contact with the inner surface 430 before the cap 406 is fully decoupled from the first upper tube 210. As shown by the airflow line in FIG. 10, pressurized air in the sealed pressure chamber 416 can flow through the vent groove 924 and vent to the atmosphere, thereby depressurizing the sealed pressure chamber 416 before the cap 406 is fully decoupled or unscrewed from the first upper tube 210. Thus, by the time the cap 406 is fully unscrewed, the sealed pressure chamber 416 is already depressurized. As a result, there is little or no risk of parts being ejected from the sealed pressure chamber 416.

While the example air spring 414 is described in connection with the front fork 200, the example air spring 414 can be similarly implemented in other bicycle components, such as a rear shock absorber or a height adjustable seat post. Thus, any of the example air springs and/or aspects of the air springs disclosed herein can be implemented in other types of bicycle components. Further, any of the example air springs and/or aspects of the air springs disclosed herein can be similarly implemented in a damper. For example, dampers often include a sealed chamber (e.g., with hydraulic fluid), a piston, and one or more sealheads and/or caps that seal the ends of the chamber. Any of the example retaining features and/or venting features can likewise be implemented in a damper.

Example systems, apparatus, method, and articles of manufacture for bicycles (and/or other vehicles) are disclosed herein. Examples and combinations of examples disclosed herein include the following:

Example 1 is an air spring for a bicycle component, the air spring comprising: a tube having a first end and a second end opposite the first end; a cap coupled to the tube at or near the first end; a sealhead in the tube near the second end such that a sealed pressure chamber is formed in the tube between the cap and the sealhead; a spacer in the tube, the spacer disposed between the sealhead and the second end; a first retaining element coupled to an inner surface of the tube and engaged by an end of the spacer to prevent the spacer from moving axially out of the second end of the tube; and a second retaining element coupled to the inner surface of the tube, the second retaining element spaced further from the second end than the first retaining element, the second retaining element having an inner diameter that is less than an outer-most diameter of the sealhead such that the second retaining element blocks the sealhead from exiting the second end of the tube.

Example 2 includes the air spring of Example 1, wherein the sealhead has a flange defining the outer-most diameter, and wherein the sealhead has an extension portion extending from the flange toward the second end, the extension portion having an outer diameter that is less than the inner diameter of the second retaining element, such that when the sealhead is moved toward the second end, the flange engages the second retaining element and the extension portion extends through the second retaining element.

Example 3 includes the air spring of Examples 1 or 2, wherein a first section of the tube has a first inner diameter and a second section of the tube adjacent the second end has a second inner diameter that is larger than first inner diameter.

Example 4 includes the air spring of Example 3, wherein the sealhead has a flange engaged with a shoulder formed between the first section and the second section.

Example 5 includes the air spring of Examples 3 or 4, further including a seal coupled to the sealhead and in sealing contact with the inner surface of the tube along the first section.

Example 6 includes the air spring of Example 5, wherein the second retaining element is coupled to the inner surface of the tube along the second section and spaced from the second retaining element, such that when the sealhead is moved toward the second end, the seal moves into the second section of the tube and loses sealing contact with the inner surface.

Example 7 includes the air spring of any of Examples 1-6, further including: a piston in the sealed pressure chamber; and a rod coupled to the piston.

Example 8 includes the air spring of Example 7, wherein the rod extends through a channel in the sealhead.

Example 9 includes the air spring of Example 8, further including a piston seal coupled to the piston, the piston seal in sealing contact with the inner surface of the tube such that the piston seal divides the sealed pressure chamber into a first chamber between the piston seal and the cap and a second chamber between the piston seal and the sealhead.

Example 10 includes the air spring of Example 9, wherein the inner surface of the tube has a recess, and wherein the recess is between the piston seal and the second end when the piston is in a top-out position such that when the first retaining element and the spacer are removed from the tube and the piston seal is moved toward the second end, the piston seal at least partially overlaps with the recess and loses sealing contact with the inner surface to enable airflow between the first and second chambers.

Example 11 includes the air spring of any of Examples of 1-10, wherein the cap and the tube are threadably coupled along an axial interface locking length, wherein the air spring includes a seal coupled to the cap and in sealing contact with the inner surface of the tube.

Example 12 includes the air spring of Example 11, wherein the cap has external threads, and wherein an outer surface of the cap has a vent groove that extends in an axial direction through the external threads.

Example 13 includes the air spring of Example 12, wherein the seal is spaced from the first end of the tube by a seal gap that is less than the axial interface locking length, such that as the cap is being unscrewed from the tube, the seal loses sealing contact with the inner surface before the cap is fully decoupled from the tube.

Example 14 includes the air spring of any of Examples 1-13, wherein the first and second retaining elements are circlips.

Example 15 includes the air spring of any of Examples 1-14, wherein the sealed pressure chamber is filled with pressurized air.

Example 16 is an air spring for a bicycle component, the air spring comprising: a tube having a first end and a second end opposite the first end; a piston in the tube; a rod coupled to the piston; a sealhead in the tube near the second end, the rod extending through a channel in the sealhead; a spacer in the tube to space the sealhead from the second end, the spacer having a first end and a second end opposite the first end, the second end of the spacer closest to the second end of the tube; and a retaining element coupled to an inner surface of the tube, the retaining element located further from the second end of the tube than the second end of the spacer, the retaining element having an inner diameter that is less than an outer-most diameter of the sealhead, such that when the spacer is removed from the tube, the sealhead is moveable toward the second end of the tube but blocked by the retaining element from exiting the second end of the tube.

Example 17 includes the air spring of Example 16, wherein the retaining element is not in contact with the spacer.

Example 18 includes the air spring of Examples 16 or 17, wherein the retaining element is a circlip.

Example 19 includes the air spring of any of Examples 16-18, wherein the spacer is cylindrical.

Example 20 includes the air spring of any of Examples 16-19, further including a piston seal coupled to the piston, the piston seal in sealing contact with the inner surface of the tube, the inner surface of the tube having a recess, and wherein the recess is between the piston seal and the second end of the tube when the piston is in a top-out position.

Example 21 is an air spring for a bicycle component, the air spring comprising: a tube having a first end and a second end opposite the first end, the tube having internal threads adjacent the first end, the tube defining a sealed pressure chamber; a cap coupled threadably coupled to the tube, the cap having external threads that are threadably engaged with the internal threads on the tube and defining an axial interface locking length, wherein an outer side surface of the cap has a vent groove that extends in an axial direction through the external threads; and a seal coupled to the cap and in sealing contact with an inner surface of the tube, wherein the seal is spaced from the first end of the tube by a seal gap that is less than the axial interface locking length such that as the cap is being unscrewed from the tube, the seal loses sealing contact with the inner surface before the cap is fully decoupled from the tube and the vent groove enables fluid to vent from the sealed pressure chamber.

Example 22 includes the air spring of Example 21, further including a valve disposed in a channel formed through the cap.

Example 23 includes the air spring of Examples 21 or 22, wherein the seal is disposed in a seal gland formed in the outer side surface of the cap.

Example 24 includes the air spring of Example 23, wherein the vent groove extends axially from an end of the cap to the seal gland.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. An air spring for a bicycle component, the air spring comprising:
a tube having a first end and a second end opposite the first end;
a cap coupled to the tube at or near the first end;
a sealhead in the tube between the cap and the second end such that a sealed pressure chamber is formed in the tube between the cap and the sealhead;
a spacer in the tube, the spacer disposed between the sealhead and the second end;
a first retaining element coupled to an inner surface of the tube and engaged by an end of the spacer to prevent the spacer from moving axially out of the second end of the tube; and
a second retaining element coupled to the inner surface of the tube, the second retaining element spaced further from the second end than the first retaining element is spaced from the second end, the second retaining element sized and shaped such that the second retaining element blocks the sealhead from exiting the second end of the tube.

2. The air spring of claim 1, wherein the sealhead has a flange defining an outer-most diameter, and wherein the sealhead has an extension portion extending from the flange toward the second end, the extension portion having an outer diameter that is less than an inner diameter of the second retaining element, such that when the sealhead is moved toward the second end, the flange engages the second retaining element and the extension portion extends through the second retaining element.

3. The air spring of claim 1, wherein a first section of the tube has a first inner diameter and a second section of the tube adjacent the second end has a second inner diameter that is larger than first inner diameter.

4. The air spring of claim 3, wherein the sealhead has a flange engaged with a shoulder formed between the first section and the second section.

5. The air spring of claim 3, further including a seal coupled to the sealhead and in sealing contact with the inner surface of the tube along the first section.

6. The air spring of claim 5, wherein the second retaining element is coupled to the inner surface of the tube along the second section and spaced from the second retaining element, such that when the sealhead is moved toward the second end, the seal moves into the second section of the tube and loses sealing contact with the inner surface.

7. The air spring of claim 1, further including:
a piston in the sealed pressure chamber; and
a rod coupled to the piston, wherein the rod extends through a channel in the sealhead.

8. The air spring of claim 7, further including a piston seal coupled to the piston, the piston seal in sealing contact with the inner surface of the tube such that the piston seal divides the sealed pressure chamber into a first chamber between the piston seal and the cap and a second chamber between the piston seal and the sealhead.

9. The air spring of claim 8, wherein the inner surface of the tube has a recess, and wherein the recess is between the piston seal and the second end when the piston is in a top-out position such that when the first retaining element and the spacer are removed from the tube and the piston seal is moved toward the second end, the piston seal at least partially overlaps with the recess and loses sealing contact with the inner surface to enable airflow between the first and second chambers.

10. The air spring of claim 1, wherein the cap and the tube are threadably coupled along an axial interface locking length, wherein the air spring includes a seal coupled to the cap and in sealing contact with the inner surface of the tube.

11. The air spring of claim 10, wherein the cap has external threads, and wherein an outer surface of the cap has a vent groove that extends in an axial direction through the external threads.

12. The air spring of claim 11, wherein the seal is spaced from the first end of the tube by a seal gap that is less than the axial interface locking length, such that as the cap is being unscrewed from the tube, the seal loses sealing contact with the inner surface before the cap is fully decoupled from the tube.

13. The air spring of claim 1, wherein the first and second retaining elements are circlips.

14. An air spring for a bicycle component, the air spring comprising:
a tube having a first end and a second end opposite the first end;
a piston in the tube;
a rod coupled to the piston;
a sealhead in the tube near the second end, the rod extending through a channel in the sealhead;
a spacer in the tube to space the sealhead from the second end, the spacer having a first end and a second end opposite the first end, the second end of the spacer closest to the second end of the tube; and
a retaining element coupled to an inner surface of the tube, the retaining element located further from the second end of the tube than from the second end of the spacer, the retaining element having an inner diameter that is less than an outer-most diameter of the sealhead, such that when the spacer is removed from the tube, the sealhead is moveable toward the second end of the tube but blocked by the retaining element from exiting the second end of the tube.

15. The air spring of claim 14, wherein the retaining element is not in contact with the spacer.

16. The air spring of claim 14, wherein the retaining element is a circlip.

17. The air spring of claim 14, further including a piston seal coupled to the piston, the piston seal in sealing contact with the inner surface of the tube, the inner surface of the tube having a recess, and wherein the recess is between the piston seal and the second end of the tube when the piston is in a top-out position.

18. An air spring for a bicycle component, the air spring comprising:
a tube having a first end and a second end opposite the first end, the tube having internal threads adjacent the first end, the tube defining a sealed pressure chamber;
a cap coupled threadably coupled to the tube, the cap having external threads that are threadably engaged with the internal threads on the tube and defining an axial interface locking length, wherein an outer side surface of the cap has a vent groove that extends in an axial direction through the external threads; and
a seal coupled to the cap and in sealing contact with an inner surface of the tube, wherein the seal is spaced from the first end of the tube by a seal gap that is less than the axial interface locking length such that as the cap is being unscrewed from the tube, the seal loses sealing contact with the inner surface before the cap is fully decoupled from the tube and the vent groove enables fluid to vent from the sealed pressure chamber.

19. The air spring of claim 18, further including a valve disposed in a channel formed through the cap.

20. The air spring of claim 18, wherein the seal is disposed in a seal gland formed in the outer side surface of the cap, and wherein the vent groove extends axially from an end of the cap to the seal gland.
